(19) United States
(12) Patent Application Publication
(10) Pub. No.: US 2011/0312286 A1
(43) Pub. Date: Dec. 22, 2011

(54) Activating Dormant Wireless Circuitry Using Motion or Incident Light

(75) Inventors: Chang-Ming Lin, San Jose, CA (US); Yu-Chih Chen, Danville, CA (US)

(73) Assignee: RFMARQ, INC., Monte Sereno, CA (US)

(21) Appl. No.: 13/160,298

(22) Filed: Jun. 14, 2011

Related U.S. Application Data
(60) Provisional application No. 61/355,801, filed on Jun. 17, 2010.

(51) Int. Cl. H04B 1/38

(52) U.S. Cl. 455/73

(57) ABSTRACT

A wireless device includes a controller and a wireless transceiver where the controller is operative to place the wireless transceiver in a low power consumption mode based on predefined energy saving control policy. In one embodiment, the wireless device includes an accelerometer generating an output signal indicative of motion or vibration of the wireless device where the output signal of the accelerometer is applied to cause the wireless transceiver to exit from the low power consumption mode. In another embodiment, the wireless device includes a photovoltaic module generating an output voltage signal indicative of incident light impinging on the photovoltaic module where the output voltage signal of the photovoltaic module is applied to cause the wireless transceiver to exit from the low power consumption mode.

### CROSS-REFERENCE TO RELATED APPLICATIONS

This application claims the benefit of U.S. Provisional Patent Application Ser. No. 61/355,801, filed on Jun. 17, 2010, which application is incorporated herein by reference in its entirety.

### FIELD OF THE INVENTION

The invention relates to energy saving systems and methods for wireless communication devices and, in particular, to systems and methods for activating a wireless circuit that is in a dormant or sleep mode.

### DESCRIPTION OF THE RELATED ART

In order to prolong battery life on hand-held wireless devices, hand-held wireless devices oftentimes implement a power management feature that places the wireless devices in a dormant or sleep mode automatically to reduce power consumption. Reactivating a dormant wireless device often requires the user to perform a wake-up operation through the user interface of the wireless device. The wake-up operation usually takes time and requires user physical handlings.

### SUMMARY OF THE INVENTION

According to one embodiment of the present invention, a wireless device includes a controller in communication with a wireless transceiver where the wireless transceiver is configured to transmit and receive data on an antenna and the controller is operative to place the wireless transceiver in a low power consumption mode based on predefined energy saving control policy. The wireless device further includes an accelerometer generating an output signal indicative of motion or vibration of the wireless device where the output signal of the accelerometer is applied to cause the wireless transceiver to exit from the low power consumption mode and to enter an active mode capable of transmitting and receiving data on the antenna.

According to another embodiment of the present invention, includes a controller in communication with a wireless transceiver where the wireless transceiver is configured to transmit and receive data on an antenna and the controller is operative to place the wireless transceiver in a low power consumption mode based on predefined energy saving control policy. The wireless device further includes a photovoltaic module generating an output voltage signal indicative of incident light impinging on the photovoltaic module where the output voltage signal of the photovoltaic module is applied to cause the wireless transceiver to exit from the low power consumption mode and to enter an active mode capable of transmitting and receiving data on the antenna.

According to another embodiment of the present invention, a method in a wireless device for activating a dormant wireless transceiver circuit in the wireless device includes detecting motion or vibration of the wireless device; generating an output signal indicative of the detected motion or vibration; and activating the wireless transceiver circuit to an active mode in response to the output signal indicating detected motion or vibration.

According to another embodiment of the present invention, a method in a wireless device for activating a dormant wireless transceiver circuit in the wireless device includes detecting incident light impinging on a photovoltaic module of the wireless device; generating an output signal indicative of the detected incident light; and activating the wireless transceiver circuit to an active mode in response to the output signal indicating detected incident light.

The present invention is better understood upon consideration of the detailed description below and the accompanying drawings.

### BRIEF DESCRIPTION OF THE DRAWINGS

FIG. 1 is a block diagram of a wireless device implementing the dormant wireless circuitry activation system according to a first embodiment of the present invention.

FIG. 2 is a block diagram of a wireless device implementing the dormant wireless circuitry activation system according to a second embodiment of the present invention.

FIG. 3 is a block diagram of a wireless device implementing the dormant wireless circuitry activation system according to a third embodiment of the present invention.

FIG. 4 is a block diagram of a wireless device implementing the dormant wireless circuitry activation system according to a fourth embodiment of the present invention.

### DETAILED DESCRIPTION OF THE PREFERRED EMBODIMENTS

In accordance with the principles of the present invention, a wireless circuit in a wireless device that is placed in a dormant mode is activated by motions of the wireless device or by incident light impinging on a light-sensitive area of the wireless device. In one embodiment, motions of the wireless device are detected by an accelerometer and the detected motion is used to trigger the wake-up operation of the dormant wireless circuit. In another embodiment, incident light impinges on a photovoltaic device of the wireless device and the photovoltaic device generates electric signals in response to trigger the wake-up operation of the dormant wireless circuit. The dormant wireless circuitry activation systems and methods of the present invention reduce the amount of user interface required to activate the dormant circuitry, thereby improving the user experience.

In the present description, a “wireless device” refers to a hand-held wireless device or mobile device capable of wireless communication. A wireless device thus includes at least an antenna, a wireless transceiver circuit (or transmit/receive circuits) and a controller. Wireless devices may include mobile telephones, personal digital assistants, tablet computers and other mobile computing devices with wireless communication functions.

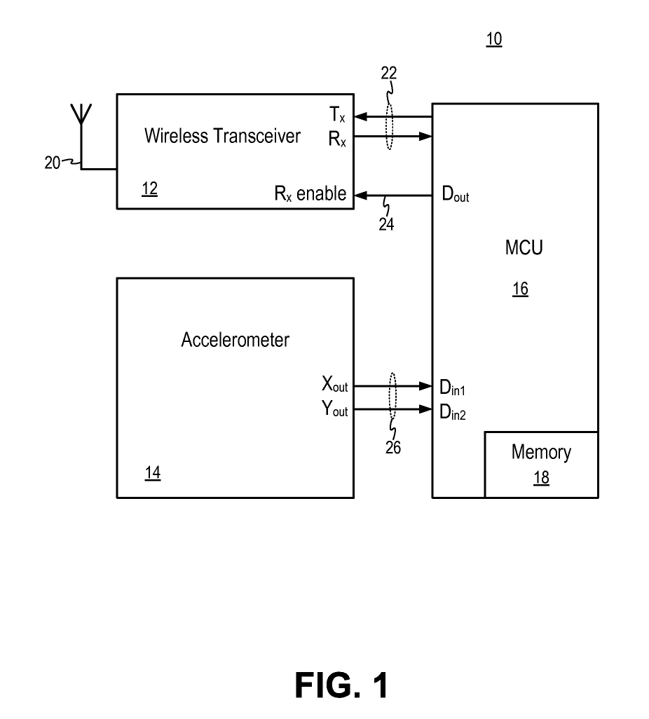

FIG. 1 is a block diagram of a wireless device implementing the dormant wireless circuitry activation system according to a first embodiment of the present invention. Referring to FIG. 1, a wireless device 10 includes a wireless transceiver 12 supporting transmit and receive communication functions on an antenna 20. The wireless device 10 further includes a micro-controller device (MCU) 16 for controlling the operation of the wireless device. The wireless transceiver 12 and the MCU 16 communicate over a bus 22 for transferring receive (Rx) and transmit (Tx) data frames between the two units. More specifically, the wireless transceiver 12 transmits Rx data frames received on antenna 20 to the MCU 16 on bus 22 and receives Tx data frames to be transmitted from the MCU 16 for transmission on antenna 20.

To implement the dormant wireless circuitry activation system in accordance with the present invention, the wireless device 10 incorporates an accelerometer 14. Accelerometers for measuring movements and vibration of an object are well known in the art. More specifically, an accelerometer is an electromechanical device that measures acceleration forces. These forces may be static, such as the constant force of gravity pulling at an object, or the forces could be dynamic, such as those caused by moving or vibrating the accelerometer. By measuring the amount of static acceleration due to gravity, the angle at which an object is tilted with respect to the earth can be determined. By sensing the amount of dynamic acceleration, the way an object is moving can be determined.

In the wireless device 10, the accelerometer 14 generates output signals Xₒᵤₜ and Yₒᵤₜ indicative of detected motion or vibration of the wireless device. The output signals Xₒᵤₜ and Yₒᵤₜ are provided to the MCU 16 as data inputs Dᵢₙ₁ and Dᵢₙ₂ on a bus 26. In response, the MCU 16 generates a control signal Dₒᵤₜ for the wireless transceiver 12 on a bus 24. The control signal Dₒᵤₜ drives a receive enable signal of the wireless transceiver 12 to control the operation modes of the wireless transceiver. The accelerometer 14 is typically powered by the power source of the wireless device 10. The accelerometer 14 may be powered by the same power source supplying the MCU 16.

In operation, the MCU 16 causes wireless transceiver 12 to enter a low power consumption mode based on certain power saving control policy. The low power mode may involve shut down of some or all of the circuitry in the wireless transceiver 12. Furthermore, the MCU 16 may itself enter a low power mode, such as by operating at a reduced clock rate. When the wireless transceiver 12 is in the low power consumption mode, the wireless device 10 is said to be dormant or in a sleep mode and does not transmit or receive data. The wireless device 10 is provided with mechanisms to allow the user to activate the wireless device when desired. In the present description, activating the wireless device (also described as “waking up” the wireless device) refers to powering up of the circuitry of the wireless transceiver 12 to enable the wireless transceiver 12 to transmit and receive data on the antenna 20. In the following description, the wireless transceiver 12 is said to be in an active mode when its circuitry is powered up and the wireless transceiver 12 is capable of receiving or transmitting data on the antenna 20.

In accordance with embodiments of the present invention, when the user wishes to activate a dormant wireless device 10, the user shakes or moves the wireless device. The accelerometer 14 detects motion or vibration of the wireless device 10 induced by the user and converts the power of the mechanical energy due to the vibration or the movement into electrical output signals Xₒᵤₜ and Yₒᵤₜ. The electrical output signals Xₒᵤₜ and Yₒᵤₜ are provided to the MCU 16, which recognizes the need to wake, up the wireless transceiver 12. The MCU 16 in turn generates the control signal Dₒᵤₜ to drive the Rx enable signal of the wireless transceiver 12. In this manner, the wireless transceiver 12 is activated and ready to receive incoming data frames on the antenna 20. In some embodiments, when the MCU 16 is also in a low power mode, the MCU recognizes the data inputs Dᵢₙ₁ and Dᵢₙ₂ as a wake-up interrupt signal and exits the low power mode, such as by increasing the clock rate.

In some embodiments, the control signal Dₒᵤₜ operates to turn on a power source supplying power to the wireless transceiver 12 in order to activate the wireless transceiver. Other methods for activating the wireless transceiver may be used and the activation methods may be dependent on how the low power consumption mode is implemented. The exact method for activating the wireless transceiver from a low power consumption mode is not critical to the practice of the present invention.

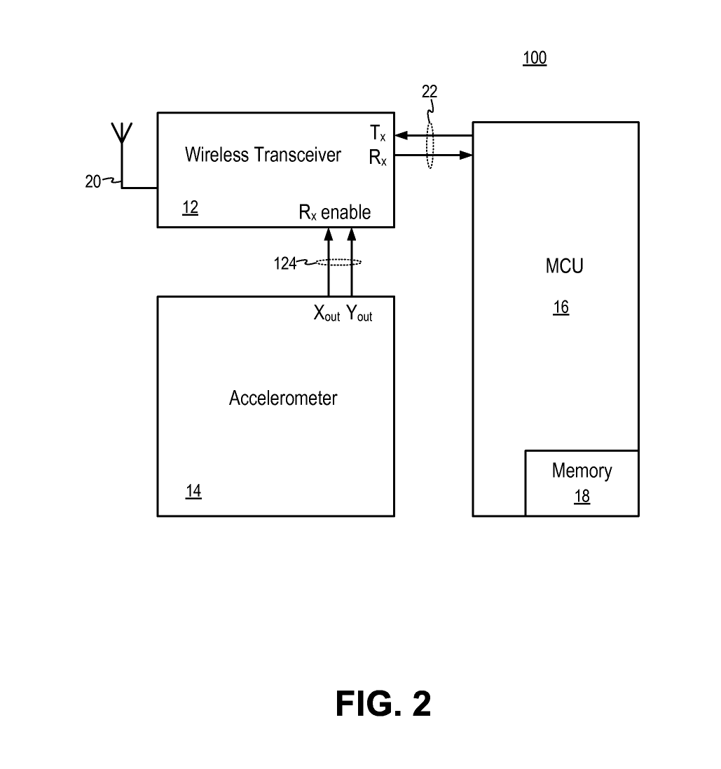

In another embodiment, the accelerometer may drive the wireless transceiver directly and power on the wireless transceiver without requiring control signals from the MCU. FIG. 2 is a block diagram of a wireless device implementing the dormant wireless circuitry activation system according to a second embodiment of the present invention. Referring to FIG. 2, a wireless device 100 is constructed in the same manner as the wireless device 10 in FIG. 1. Like elements in FIGS. 1 and 2 are given like reference numerals and will not be further descried. In wireless device 100, the accelerometer 14 generates electrical output signals Xₒᵤₜ and Yₒᵤₜ which are provided directly to the wireless transceiver 12 on a bus 124 to control the activation of the wireless transceiver. Thus, with the wireless transceiver 12 is in a low power consumption mode, when the accelerometer 14 detects motion or vibration, the accelerometer 14 generates electrical output signals Xₒᵤₜ and Yₒᵤₜ to drive the Rx enable signal of the wireless transceiver 12. In this manner, the wireless transceiver 12 is activated and ready to receive incoming data frames on the antenna 20.

According to embodiments of the present invention, the dormant wireless circuitry activation system is applied advantageously to wireless devices incorporating an electronic identity card, electronic credit card or electronic wallet to implement personal identification verification or financial transaction functions. In one embodiment, a subscriber identity module (“SIM card”) has stored thereon unique financial information, such as the credit card information or the bank account number information, of the user to allow the SIM card to function as an electronic credit card or electronic wallet. Alternately, the SIM card may store thereon unique user identification information to allow the SIM card to function as an electronic identification, such as an electronic passport. The SIM card may be incorporated in a wireless device, such as a mobile phone. In embodiments of the present invention, the mobile phone implements the dormant wireless circuitry activation system described above with reference to FIGS. 1 and 2. Accordingly, the mobile phone incorporates an accelerometer for activating the wireless transceiver circuitry in accordance with the dormant wireless circuitry activation system and method described above.

In operation, the mobile phone may be turned off or placed in a dormant mode to reduce power consumption. However, when the user wishes to use the electronic credit card or electronic wallet or the electronic identification, the user may shake or vibrate the mobile phone to activate the wireless transceiver of the mobile phone. The motion or movement of the mobile phone is detected by the accelerometer and the accelerometer in turn activates the wireless transceiver to allow the SIM card to engage in wireless communication. In this manner, the user of the mobile phone may realize power saving by putting the mobile phone in a low power consumption mode but may very quickly wake up the wireless transceiver to perform financial transactions or identification transactions without waking up the entire mobile phone. The user may simply shake or vibrate the mobile phone to activate the wireless transceiver so that financial or identification transactions through the SIM card may be carried out.

In other embodiments of the present invention, the dormant wireless circuitry activation system may be applied advantageously to wireless devices implementing other data transaction functions, such as product or services authentication, and other data transactions requiring unique user identification.

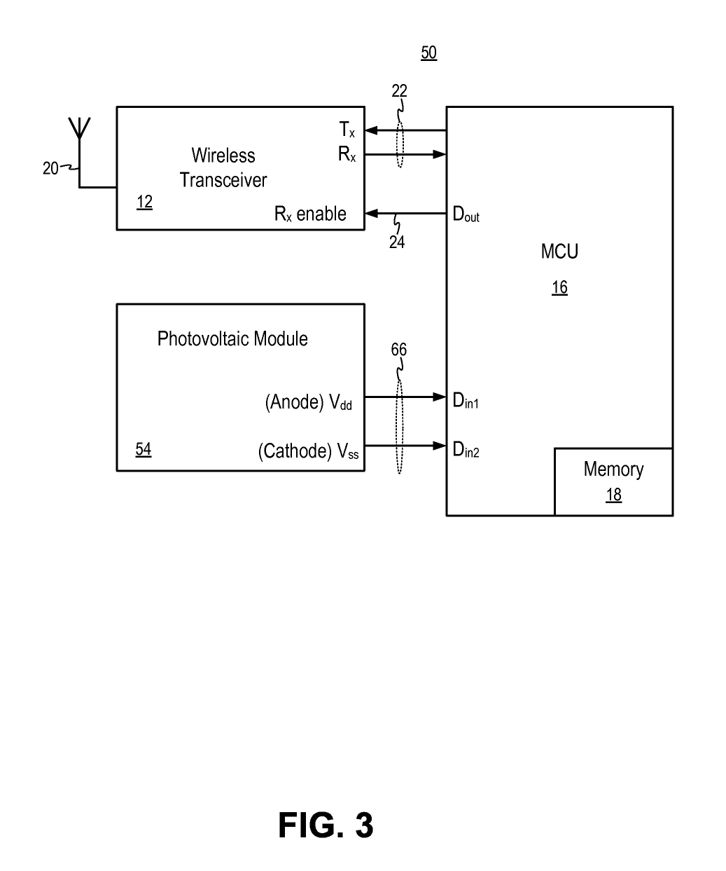

According to another aspect of the present invention, instead of using motion or vibration to activate a dormant wireless circuitry, the dormant wireless circuitry activation system uses incident radiation, such as light, as an indicator to wake up a dormant wireless circuit. FIG. 3 is a block diagram of a wireless device implementing the dormant wireless circuitry activation system according to a third embodiment of the present invention. Referring to FIG. 3, a wireless device 50 is constructed in a similar manner as the wireless device 10 in FIG. 1. Like elements in FIGS. 1 and 3 are given like reference numerals and will not be further descried. Instead of an accelerometer, the wireless device 50 includes a photovoltaic module 54 for detecting incident light. A photovoltaic module, including an array of photovoltaic cells, converts incident light energy (photons) to electricity through photovoltaic effect (i.e., the photo-electric effect). Accordingly, light impinging on the photovoltaic module 54 results in power generation and an output voltage and an output current are generated at the anode and cathode electrodes of the photovoltaic module 54. The output voltage generated by the photovoltaic module 54 is provided to the MCU 16 as data inputs Dᵢₙ₁ and Dᵢₙ₂ on a bus 66. In response, the MCU 16 generates a control signal Dₒᵤₜ for the wireless transceiver 12 on a bus 24. The control signal Dₒᵤₜ drives a receive enable signal of the wireless transceiver 12 to control the operation modes of the wireless transceiver.

In operation, when the wireless device 50 is dormant, that is, the wireless transceiver 12 is put in a low power consumption mode, the wireless transceiver 12 may be activated by exposing the photovoltaic module 54 to incident light. When the photovoltaic module 54 receives enough incident light to generate an output voltage having a desired voltage level, the MCU 16 recognizes the need to wake up the wireless transceiver 12. The MCU 16 in turn generates the control signal Dₒᵤₜ to drive the Rx enable signal of the wireless transceiver 12. In this manner, the wireless transceiver 12 is activated and ready to receive incoming data on the antenna 20. In some embodiments, when the MCU 16 is also in a low power mode, the MCU recognizes the data inputs Dᵢₙ₁ and Dᵢₙ₂ as a wake-up interrupt signal and exits the low power mode, such as by increasing the clock rate.

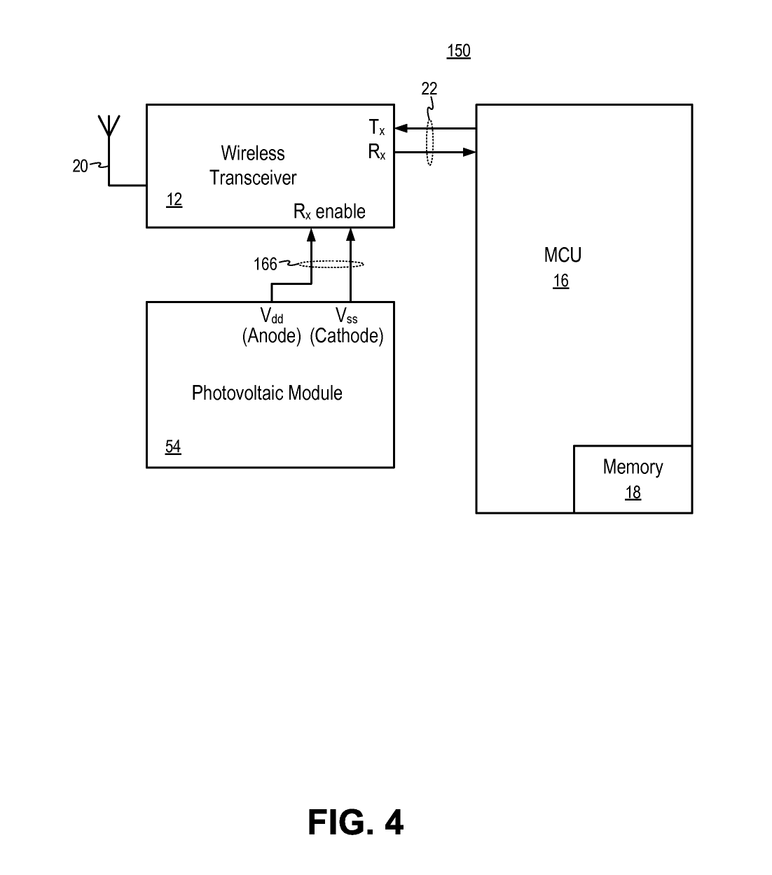

In another embodiment, the photovoltaic module may drive the wireless transceiver directly and power on the wireless transceiver without requiring control signals from the MCU. FIG. 4 is a block diagram of a wireless device implementing the dormant wireless circuitry activation system according to a fourth embodiment of the present invention. Referring to FIG. 4, a wireless device 150 is constructed in the same manner as the wireless device 50 in FIG. 3. Like elements in FIGS. 3 and 4 are given like reference numerals and will not be further descried. In wireless device 150, the photovoltaic module 54 generates an output voltage which is provided directly to the wireless transceiver 12 on a bus 166 to control the activation of the wireless transceiver. Thus, with the wireless transceiver 12 is in a low power consumption mode, the photovoltaic module 54 is exposed to incident light. When the photovoltaic module 54 receives enough incident light, the photovoltaic module 54 generates an output voltage having a sufficient magnitude to drive the Rx enable signal of the wireless transceiver 12. In this manner, the wireless transceiver 12 is activated and ready to receive incoming data frames on the antenna 20.

In embodiments of the present invention, the dormant wireless circuitry activation system utilizing a photovoltaic module is applied advantageously to wireless devices for facilitating electronic financial transactions or electronic authentication functions, in the same manner as described above. In one embodiment, a wireless phone implementing the dormant wireless circuitry activation system using a photovoltaic module may be placed in a dormant mode. When the user wishes to carry out a financial transaction or an identity authentication using the data stored in the SIM card of the mobile phone, the user may simply turn the photovoltaic module towards incident light, such as natural or artificial light source, to activate the wireless transceiver circuit. The user may then proceed with the financial transaction or identity authentication transaction.

According to other aspect of the present invention, the dormant wireless circuitry activation systems and methods described above may be used to activate circuitry other than a wireless communication circuit. More specifically, a dormant circuit activation system may be implemented in electronic devices using either an accelerometer or a photovoltaic module as described above. The output signals from the accelerometer or the photovoltaic module may then be used to wake up a dormant electrical circuit, such as an LCD display of a mobile device. In this manner, a user may simply shake or vibrate a mobile device to turn on the LCD display to retrieve display data without activating the entire mobile device. In embodiments of the present invention, the mobile device may include a tablet computer, an ebook reader, a netbook or other handheld personal entertainment devices.

The above detailed descriptions are provided to illustrate specific embodiments of the present invention and are not intended to be limiting. Numerous modifications and variations within the scope of the present invention are possible. The present invention is defined by the appended claims.

We claim:

1. A wireless device comprising a controller in communication with a wireless transceiver, the wireless transceiver being configured to transmit and receive data on an antenna, the controller being operative to place the wireless transceiver in a low power consumption mode based on predefined energy saving control policy, the wireless device further comprising:
an accelerometer generating an output signal indicative of motion or vibration of the wireless device, the output signal of the accelerometer being applied to cause the wireless transceiver to exit from the low power consumption mode and to enter an active mode capable of transmitting and receiving data on the antenna.

2. The wireless device of claim 1, wherein the accelerometer provides the output signal to the controller, the controller, in response to the output signal indicating motion or vibration of the wireless device, generates a control signal to cause the wireless transceiver to exit from the low power consumption mode and to enter the active mode.

3. The wireless device of claim 1, wherein the accelerometer provides the output signal to the wireless transceiver, the wireless transceiver, in response to the output signal indicating motion or vibration of the wireless device, exits from the low power consumption mode to enter the active mode.

4. The wireless device of claim 1, wherein the wireless device further comprises a subscriber identity module (“SIM card”) having stored there on user-specific data, the wireless transceiver being activated to the active mode to transmit the user-specific data from the SIM card.

5. The wireless device of claim 4, wherein the user-specific data comprises user financial data for facilitating financial transaction using the wireless device.

6. The wireless device of claim 4, wherein the user-specific data comprises user identification data for facilitating identity authentication using the wireless device.

7. A wireless device comprising a controller in communication with a wireless transceiver, the wireless transceiver being configured to transmit and receive data on an antenna, the controller being operative to place the wireless transceiver in a low power consumption mode based on predefined energy saving control policy, the wireless device further comprising:
a photovoltaic module generating an output voltage signal indicative of incident light impinging on the photovoltaic module, the output voltage signal of the photovoltaic module being applied to cause the wireless transceiver to exit from the low power consumption mode and to enter an active mode capable of transmitting and receiving data on the antenna.

8. The wireless device of claim 7, wherein the photovoltaic module provides the output voltage signal to the controller, the controller, in response to the output signal indicating incident light on the photovoltaic module, generates a control signal to cause the wireless transceiver to exit from the low power consumption mode and to enter the active mode.

9. The wireless device of claim 7, wherein the photovoltaic module provides the output signal to the wireless transceiver, the wireless transceiver, in response to the output signal indicating incident light on the photovoltaic module, exits from the low power consumption mode to enter the active mode.

10. The wireless device of claim 7, wherein the wireless device further comprises a subscriber identity module (“SIM card”) having stored there on user-specific data, the wireless transceiver being activated to the active mode to transmit the user-specific data from the SIM card.

11. The wireless device of claim 10, wherein the user-specific data comprises user financial data for facilitating financial transaction using the wireless device.

12. The wireless device of claim 10, wherein the user-specific data comprises user identification data for facilitating identity authentication using the wireless device.

13. A method in a wireless device for activating a dormant wireless transceiver circuit in the wireless device, the method comprising:
detecting motion or vibration of the wireless device;
generating an output signal indicative of the detected motion or vibration; and
activating the wireless transceiver circuit to an active mode in response to the output signal indicating detected motion or vibration.

14. The method of claim 13, further comprising:
providing the output signal indicative of the detected motion or vibration to a controller of the wireless device;
generating a control signal at the controller in response to the output signal indicating detected motion or vibration; and
providing the control signal to the wireless transceiver circuit to activate the wireless transceiver circuit to the active mode.

15. The method of claim 13, further comprising:
providing the output signal indicative of the detected motion or vibration directly to the wireless transceiver circuit of the wireless device.

16. The method of claim 13, further comprising:
transmitting user-specific data stored on a subscriber identity module (“SIM card”) upon activating the wireless transceiver circuit.

17. A method in a wireless device for activating a dormant wireless transceiver circuit in the wireless device, the method comprising:
detecting incident light impinging on a photovoltaic module of the wireless device;
generating an output signal indicative of the detected incident light; and
activating the wireless transceiver circuit to an active mode in response to the output signal indicating detected incident light.

18. The method of claim 17, further comprising:
providing the output signal indicative of the detected incident light to a controller of the wireless device;
generating a control signal at the controller in response to the output signal indicating detected incident light; and
providing the control signal to the wireless transceiver circuit to activate the wireless transceiver circuit to the active mode.

19. The method of claim 17, further comprising:
providing the output signal indicative of the detected incident light directly to the wireless transceiver circuit of the wireless device.

20. The method of claim 17, further comprising:
transmitting user-specific data stored on a subscriber identity module (“SIM card”) upon activating the wireless transceiver circuit.
